(19) United States
(12) Patent Application Publication
(10) Pub. No.: US 2017/0242962 A1
(43) Pub. Date: Aug. 24, 2017

(54) ONLINE MANAGED MEDICAL PORTAL FOR PATIENTS AND PHYSICIANS

(71) Applicant: UniMedSoft, Inc., Woodland Hills, CA (US)

(72) Inventor: Vladimir LENCHITSKY, Woodland Hills, CA (US)

(21) Appl. No.: 15/046,993

(22) Filed: Feb. 18, 2016

(51) Int. Cl. G06F 19/00; H04L 29/06

(52) U.S. Cl. CPC G06F 19/322; G06F 19/3456; H04L 63/10

(57) ABSTRACT

A medical management system provides a fully customized web portal to a HIPAA compliant, managed medical database and allows access and feedback from pharmacists, care providers such as nurses, therapists and psychiatrists, patients and physicians. The web portal connects to the database over a secure data channel to retrieve clinical care plans, medication/therapy management, progress notes, patient history, drug information, recommendations, and ongoing feedback. The system also continuously updates and analyzes newly received information from patients, care providers, and drug manufacturers.

### FIELD OF THE INVENTION

The invention relates to a system including a medical database for providing secure data access to patients, pharmacists, providers and physicians.

### BACKGROUND OF THE INVENTION

Digital medical records databases have been developed to make medical records easier to transfer and/or duplicate for doctors and other medical care providers. Initially medical record databases focused on patient records and simple access by doctors within a hospital or clinic. Digitized files conserved space and reduced data loss and searching time when compared to traditional paper files.

These systems usually stored files locally and did not provide access for authorized third parties or specialists. The data storage itself required maintenance and updating by the doctors or hospital and was not managed by information technology professionals. They also had limited accessibility; for instance, doctors still required paper charts with each patient currently under their care since the database was only accessible via a few terminals.

An example of one such prior art system is the U.S. Pat. No. 5,991,729 to Barry et al. which describes a medical history database with searchable patient codes, doctor codes and diagnostic codes. The associated information record aids the physician or patient in understanding the diagnosis, the basis for the diagnosis, the underlying medical condition or disease, and provides advice that should be offered a patient.

Another such system is disclosed in US patent publication 2007/0124173 to Morag et al. which is related to a medical database with numerous accessibility options for physicians in a hospital. The system also sends limited information to patients and pharmacies over encrypted data channels. The software application disclosed in this patent publication attempts to provide a comprehensive solution including billing control, client messaging, medical history storage and preventative health scheduling.

The systems described above, however, manage data locally and have only limited accessibility to other care providers. Patients, which have been referred to outside specialists, could not access the data compiled and analyzed by the primary care physicians including the diagnosis, treatment rational, or treatment guidelines. Likewise, the specialists cannot update the information in the system or provide their own input into the treatment regimen. This results in conflicting treatments and confusing, parallel therapy suggestions being provided to the patients.

Furthermore, by limiting patients' feedback, data on side-effects and dose requirements is often lost and/or ignored. This lack of data results in a “one size fits all” treatment process, which is not readily updatable, based on the current patients' experience or other patients experiences. Additionally, the systems do not provide the patient with treatment changes or progress steps over a course of treatment

These communications and updates are important especially in high-cost specialized treatment regimens for diseases such as osteoporosis, multiple sclerosis arthritis or hepatitis C. Each of these diseases requires not only targeted drug dosages but also repeated therapy treatments and daily exercise by the patient. Thus, keeping the patient on track and ensuring adherence to the prescribed treatments is important while also accepting feedback on patient difficulties and complications.

### SUMMARY OF THE INVENTION

The system provides a fully customized web-portal to a managed medical database that is secure and reliable. The portal allows access and feedback from pharmacists, care providers such as nurses, therapists and psychiatrists, patients and physicians. The system also continuously updates and analyzes newly received information from patients, care providers, and drug manufacturers.

The system also provides a Health Insurance Portability and Accountability Act (HIPAA) compliant secure data channel to retrieve clinical care plans, medication/therapy management, progress notes, patient history, drug information, recommendations, and ongoing feedback. The system further provides a sequence of processes which can ensure that the physician and patient are both well informed regarding the current and updated treatment plan.

The web portal or mobile application allows for accessibility from a variety of platforms including mobile platforms, tablets, PDAs, desktops and laptops. Alternatively, the data channel can be accessed via a software application. Separate access authorizations are permitted for care providers and patients.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 shows a schematic of the system;

FIG. 2 shows an exemplary display menu;

FIG. 3 shows an exemplary display of a prescription summary;

FIG. 4 shows an exemplary display of a progress note;

FIG. 5 shows an exemplary display of a compliance screen; and

FIG. 6 shows a process for establishing and communicating a prescription treatment plan.

### DETAILED DESCRIPTION

Exemplary embodiments of the invention will be described in detail below with use of the figures.

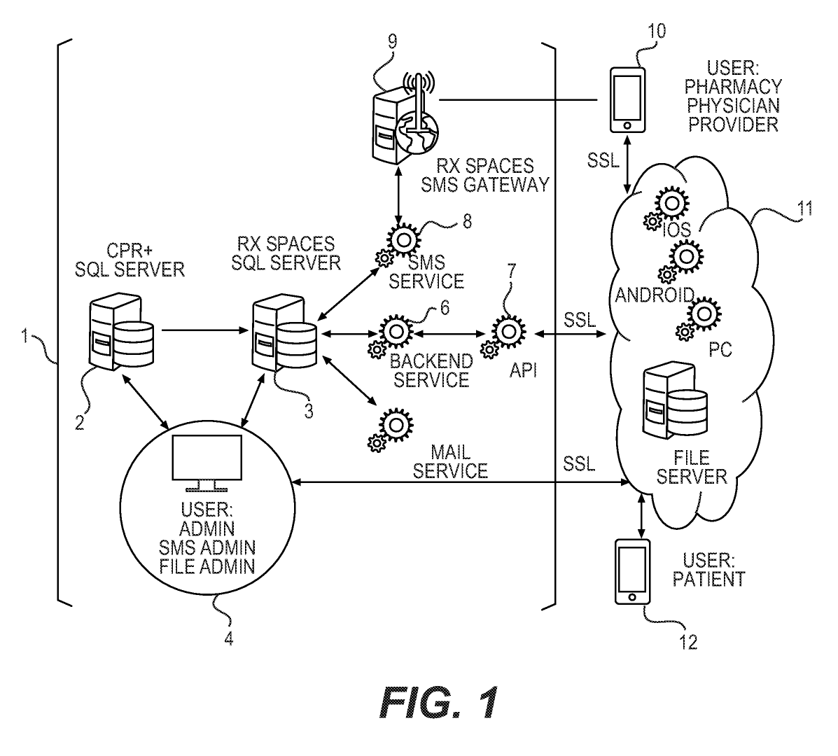

The database side of the system shown in FIG. 1 is a HIPAA compliant environment 1. The database side includes a number of databases with separate or overlapping data on patients and treatment plans. The CPR+ server 2 is accessible via a terminal or display 4 which is electrically or wirelessly connected to the CPR+ server 2, the RXSPACES server 3 and file server 11 (distributed data network). Thus, each server can be maintained and updated from the same terminal 4 and receive user information input by the user at the terminal via a graphical user interface, keyboard, mouse, and the other input devices.

The CPR+ server 2 may be an SQL server containing patient workflows, physician schedules, billing processing including disbursement and reimbursement, prescription inventory, patient follow up procedures and reporting forms. The SQL queries allow for automated form filling, inventory updates and scheduling analysis.

The RXSPACES server 2 preferably contains patient specific reviews of patient cases, medication dosages, drug utilization, side effects, reported adverse events, plan-specific instructions, specialized handling and specialized drug administration procedures. The RXSPACES server 2 can also automate individualized shipments or deliveries to patients or physicians, ensure proper shipping requirements (e.g. temperature controlled, next-day delivery), track shipments and customer receipt, providing ancillary supplies (e.g. needles, gauze, alcohol swabs, and refill procedures).

The RXSPACES server 2 is configured to receive patient information from the CPR+ server 1 that details the dosage requirements and treatment plan. This information from server 1 can then be transformed into the data format of server 2 and expanded using the drug specific information in server 2. Alternatively, the CPR+ server can provide the basic patient information which is then added to by the various care providers connected with the RXSPACES server 2. This allows the drug specific information to be changed easily as treatments change or the treatment progresses without direct access to the confidential patient identifying information. This allows for an optimized treatment plan to be generated based on a physicians recommendation. This optimized plan provides additional information to the patient and pharmacist.

The integrated system interacts with patients and doctors directly to determine medical necessity requirements, adapts existing guidelines to meet individual needs, and incorporates plan-specific criteria as necessary via specialized Medication Therapy Management (MTM) programs. Furthermore, the system can integrate directly with health plans and physicians to assist in communicating authorization requests and obtain plan approval prior to dispensing.

The RXSPACES server 2 integrates with a mail service system 5 which automates and coordinates shipment of medications and supplies to patients and physicians. The mail server system 5 tracks refill deadlines, medication expirations in the field, prints shipping labels and schedules delivery and pickup with various mail delivery service providers.

The server 2 also hosts a backend service 6 which connects via an Application Program Interface (API) 7 to a cloud-based file server 11. The connection to the cloud-based file server is preferably a secure SSL or SSH connection that provides information needed by third parties. The backend service also provides a reminder service which serves notices to patient mobile devices 12, reminding them of dosage changes, the importance of maintaining the current treatment plan, the number of days left on the treatment plan, medicines which cannot be taken with the currently administered drugs, or scheduled appointments with care providers.

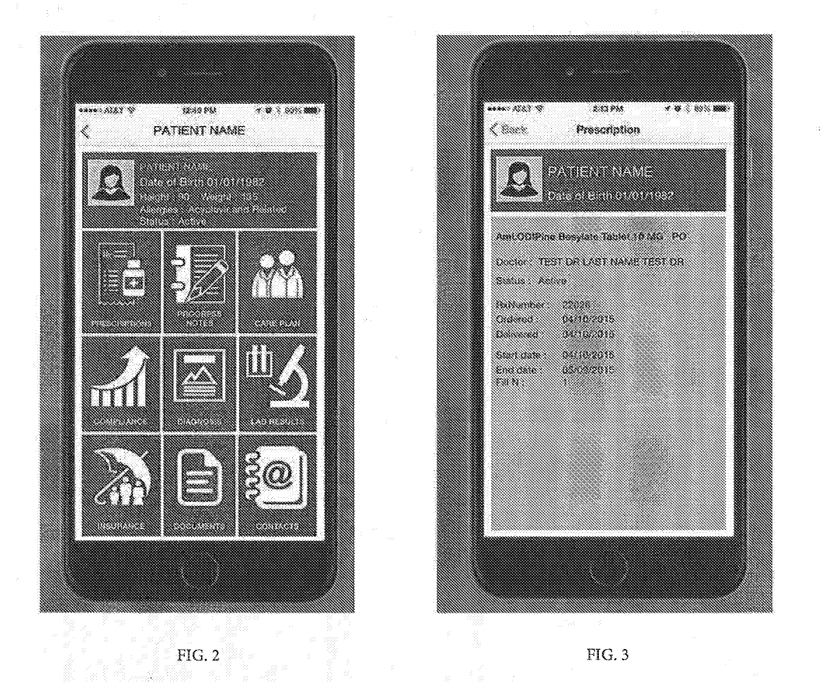

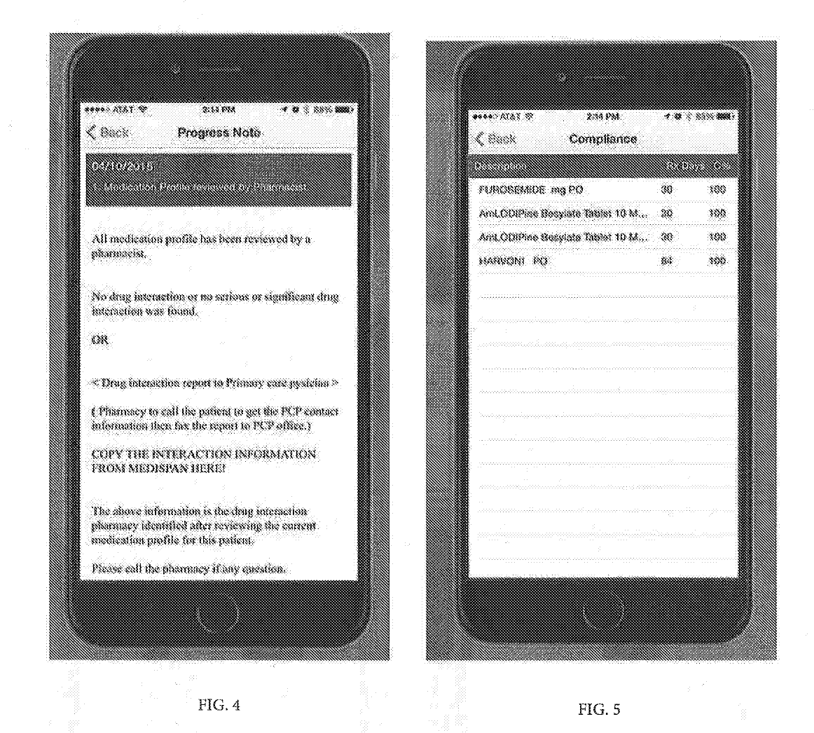

The server 2 also provides a SMS service 8 that connects to an SMS gateway 9 capable of sending text messages to a first mobile device 10 held by pharmacies, physicians and providers via a transceiver. The first mobile device can also host a software application which scans the text message and also interfaces with the file server 11 via a secure connection. The software application on the first mobile device would relay specific information needed by the care provider as seen in FIG. 2, FIG. 3, FIG. 4. And FIG. 5.

In particular, FIG. 2 displays a menu of the different data types and services offered by the application. FIG. 3 illustrates an exemplary patient prescription authorization. FIG. 4 shows the ongoing progress of the patient and any adverse events, especially drug interactions or experienced side effects. FIG. 5 displays for the pharmacist or doctor the complete list of prescriptions being taken by the patient. These patient-specific screens allow for quick case reviews by the outside care providers.

Case review is a highly recommended process to promote appropriate medication use that is consistent with the benefit. Case review is a vital part of the overall clinical management and cost management and is accomplished through a dedicated team of clinical staff interacting by phone, email, and/or fax with the requesting physician offices. For eligible members and covered services, cases are reviewed using evidenced-based guidelines.

For instance, a clinical pharmacist can solidify all specialty medication case review decisions including reviewing the dose quantity and drug utilization for every medicine. Using evidence-based literature, the system also supports development of clinical recommendations based on suitable guideline criteria and communicates industry updates as new drug therapies emerge on the market.

In addition, the user or patient can also have a real-time, direct access to the file server 11 through a second mobile device 12. This software application run on the user's phone or tablet can serve reminders, plan updates and progress, collect feedback, and send/receive alerts. Alternatively, the user can access the same service via a web portal.

Member education is a key part of a successful specialty pharmacy program. Well-informed members can better manage their chronic conditions, and are more likely to adhere to therapy and make healthy lifestyle choices. This can result in improved member outcomes and satisfaction, and reduce catastrophic medical events, absenteeism, and overall health care costs.

The curriculum for patient users can cover over 20 conditions or medication based education topics for a variety of serious chronic diseases. These diseases treatment plans can include Hepatitis C, Rheumatoid Arthritis, Oral and IV Oncology, Intravenous Immunoglobulin (IVIG), Multiple Sclerosis (MS), Crohn's disease, total parenteral nutrition (TPN) and various sexually transmitted infections (STI), for example.

The backend service 6 provides proactive refill reminders and side effect management by phone to encourage user compliance, allowing the user to notify the provider if compliance issue is identified, explaining unit/dose packaging (med strips, blister packs, timer caps), and providing adherence monitoring, measuring, and reporting (medication possession ratios)

Medication compliance is crucial to the effectiveness of a user's treatment program for a chronic disease. The medication compliance program helps patients stay on track with the physician's prescribed medication regimen.

As directed by the system, patient care coordinators call the user prior to each scheduled refill and coordinate the next prescription delivery. Up to three phone attempts are made prior to the user's scheduled refill date. If unable to reach the member though these calls, the system schedules a follow-up call one week after the scheduled refill. The physician is then notified if there is no contact or follow-up from the user.

The MTM program services for patients include, but are not limited to, the following: one-on-one phone consultations with a registered nurse or clinical pharmacist, personalized care plans highlighting the key issues, goals, and outcomes discussed during the consultations, system management tips related to the medical condition and side effect management, reference foto additional resources provided by CPR+, THERIGY Specialty Therapy Management (STM), MHA CTM, and any other resources or databases that may be of value, refill reminder calls and follow-up calls as needed or as requested by patient/prescriber, and proactive identification and intervention for at-risk members for medication non-adherence via a high risk patient care program.

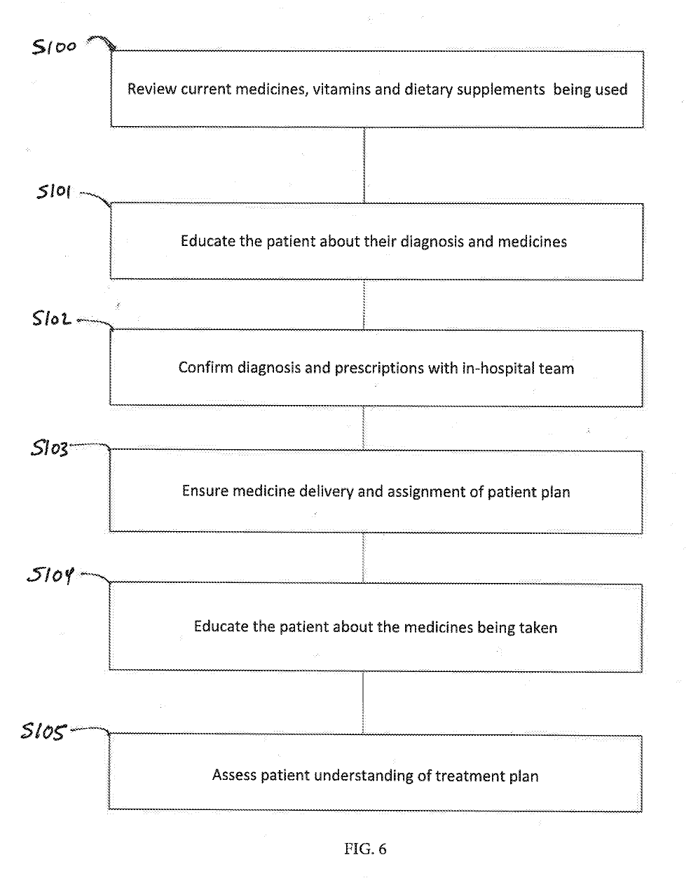

The RXSPACES server 2 assumes the role of a discharge pharmacy educator and functions as an outpatient pharmacy. Specifically, the system performs the process shown in FIG. 6 that identifies the current and best medicines for the patient to take S100, educates the patient about the diagnosis and medicines S101, confirms the prescription with the hospital team S102, insures delivery S103, educates the patient prescribed medicines S104, and assesses the patient's understanding of the instructions S105.

The first step S100 can include a review all medicine lists with the patient, including, when possible, the inpatient medicine list, the outpatient medicine list, as well as what the patient reports taking. Furthermore, it is important to ascertain what vitamins, herbal medicines, or other dietary supplements the patient takes.

In the second step S101, the system provides education on primary diagnosis and comorbidities and explains what medicines to take, emphasizing any changes in the regimen. The step also reviews each medicine's purpose and how to take each medicine correctly, and notes important side effects, while assessing the patient's concerns about the medicine plan.

In the third step S102, the system confirms the diagnosis, the medicine list for discharge and communicates any discrepancies found. It also lists, for review by the physician, information from the patient including the list of the meds taken prior to admission, medicine allergies, record of adverse reactions and side effects.

In the third step S103, the system identifies the correct medicines that the patient should take (and not take) after discharge, and arranges a way for the patient to obtain the medicine.

The purpose of medicine reconciliation in preparation for hospital discharge is to determine that the patient's discharge medicine list and discharge summary medicine list reflect the most recent and accurate updates made to the patient's medicine plan.

After compiling and cross-checking the data lists provided by the outside pharmacy, the patient or family members and doctor, the system identifies any potential interactions with prescription medicines. The system then highlights any discrepancies for the medical team and identifies what medicines the patients should and should not be taking. Thus, before discharge, all discrepancies in the medicine list can be discovered and resolved.

In the fifth step S104, the system teaches the patient about their treatment plan. Specifically, the following are addressed and reviewed for the patient: any changes to medicines (new medicines, change in dose or frequency, etc.), the correct dose, the time of day to take each medicine, what to do if they miss a dose, the reason they need to take each medicine, which medicines to continue taking and which to stop taking, how long to take it (even if symptoms go away), potential side effects of each medicine, warnings not to discontinue without calling the doctor (when appropriate), and the importance of bringing all medicines to follow-up appointments.

Finally, in the sixth step S105, the patient is tested via a mobile device 12 or a display terminal 4 to assess their understanding of the treatment plan. Follow-up and contact information can also be confirmed at this point.

Thus, the system can interact with the physician and patient via terminal 4 and mobile device 12 to ensure the above process steps are executed and that the patient is adequately aware of all changes. In fact, the patient and doctor need not be in the same room for the steps above to be executed, such that the establishment of the plan can occur remotely.

The drug utilization management evaluates the appropriateness, necessity and efficiency of the prescribed medications, based on most current established criteria or guidelines. This is performed on initial referral, prior to all refills, and when any side effects or adverse events are reported. The utilization management system of server 2 provides accessibility, education, and comprehensive guidance to physicians. The system also complies side effect information for comparison with known side effects and to educate doctors on average patient response to a medicine.

The RXSPACES server 2 adapts existing guidelines to meet individual needs based on input variables, and incorporates plan-specific criteria as necessary via specialized MTM programs. The variables or information taken from patients and stored in the system can include: patient name, patient date of birth, patient phone number, emergency contact information, primary care physician information, pharmacy/pharmacist information, allergies information, other medication-related problems, date that data or plan was last updated, date the plan was last reviewed by the pharmacist, physician, or other healthcare professional, patient's signature, and healthcare provider's signature.

Furthermore, for each medication the system stores the following: medication (e.g. drug name and dose), indication (e.g., Take for . . . ), instructions for use, start date, stop date, ordering prescriber/contact information, and special instructions.

Likewise, for each treatment plan at least the following data is stored: patient name, primary care physician, pharmacy/pharmacist, date of plan creation, actions/steps for the patient (or problems identified), notes for the patient (including goals and interventions), and appointment information for follow-ups.

The compiled data can be analyzed for trends and patterns between patients, specifically ones taking the same combination of medicines. Additionally, progress with different medicines can be tracked and reported easily. Furthermore, each of the elements of stored data is retrievable by an authorized person via the terminal 4, the first mobile device 10 of the pharmacist, and the second mobile device of the patient.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A medical management system, comprising:
at least one database server storing patient data, drug information and treatment plans;
at least one display terminal electrically or wirelessly connected to the at least one database server;
a remote file server electrically connected via secure connection to the at least one database server and the at least one display terminal; and
at least a first mobile device and a second mobile device each connected to the remote file server, wherein the at least one display terminal includes an graphical user interface that receives patient input, wherein the at least one database server running at least two processes, wherein the processes include checks for side effects, checks for drug conflicts and checks for treatment plan changes, and wherein the first mobile device provides control and update access to a care provider and the second mobile device provides plan information to at least one patient and receives patient feedback on an assigned treatment plan.

2. The medical management system of claim 1, further comprising:
a telecommunications gateway electrically connected to the at least one database server, wherein the telecommunications gateway includes a transceiver, and wherein the telecommunications gateway transmits an SMS message to the first mobile device or the second mobile device.

3. The medical management system of claim 1, wherein the remote file server is a distributed data network, and wherein the at least one database server including a backend application performs queries and updates compiled patient information on the file server.

4. The medical management system of claim 1, wherein the at least one database server includes a mail service application that automates the scheduling and mailing of prescriptions to patients.

5. The medical management system of claim 1, wherein the at least one database server receives and stores patient feedback on each treatment plan assigned to each of the at least one patient, and wherein the at least one database server analyzes the stored patient feedback and detects patterns or trends between similar patients or between similar treatment plans.

6. The medical management system of claim 5, wherein the trends or patterns include repeated side effects, new side effects, and progress comparisons between drugs or therapy plans, or a combination thereof.

7. A medical management method performed by a database server, at least one display terminal, and at least two mobile devices, comprising:
initiating an inquiry of a patient upon admission to a medical facility and receiving patient specific information including current medicine usage, current vitamin usage, current treatment plan, and current therapy via the at least one display terminal;
displaying plan information of a diagnosis, current medicine and current treatment plan via the at least one display terminal;
request authorization of the diagnosis, current medicine and current treatment plan from a physician, and if the physician does not authorize the current medicine or current treatment plan, requesting an update of the current medicine and current treatment plan, wherein the authorization is performed via the at least one display terminal;
ensure assignment of a treatment plan and coordinate medicine delivery or access via a mail delivery service or an authorized pharmacy;
display updated plan information related to the diagnosis, current medicine and current treatment plan via the at least one display terminal;
assess, via a test, the understanding of the treatment plan by the patient.

8. The medical management method of claim 7, wherein the updated plan information is displayed on one of the at least two mobile devices upon request by the patient.

9. The medical management method of claim 7, wherein the assigned treatment plan and medicine delivery or access information is displayed on one of the at least two mobile devices upon request by a care provider or the physician.

10. The medical management method of claim 7, wherein one of the at least two mobile devices allows access to patient specific information including current medicine usage, current treatment plan, current therapy, progress notes, diagnosis, and lab results.
